(19) United States
(12) Patent Application Publication
(10) Pub. No.: US 2002/0007815 A1
(43) Pub. Date: Jan. 24, 2002

(54) O-ring type rotary engine

(76) Inventors: Pill-Keun Oh, Seoul (KR); Moon-Keun Oh, Seoul (KR)

Correspondence Address: BAKER & BOTTS, 30 ROCKEFELLER PLAZA, NEW YORK, NY, 10112

(21) Appl. No.: 09/778,984

(22) Filed: Jan. 31, 2001

Related U.S. Application Data
(63) Continuation of application No. PCT/KR00/00203, filed on Mar. 13, 2000.

(30) Foreign Application Priority Data
Dec. 27, 1999 (KR) 1999 63130

(51) Int. Cl. F02B 53/04; F01C 1/356

(52) U.S. Cl. 123/236; 123/238

(57) ABSTRACT

An engine is constructed with a rotor housing having a rotor chamber formed in a cylindrical shape in the inside thereof and sealed at the opposing ends, such as by a cover at each end. At least one combustion chamber is provided which is coupled through the rotor chamber in one side thereof to provide a combustion space for a fuel mixture. A suction expansion valve is provided for opening and closing a passage directed into the combustion chamber and an intake pipe in the rotor chamber of the rotor housing. A compression exhaust valve is provided for opening and closing a passage directed into the combustion chamber and an exhaust pipe, in the rotor chamber of the rotor housing. A rotor is installed in an axial relationship within the rotor chamber of the rotor housing. The rotor includes at least one movable lug projecting therefrom. The movable lug is preferably formed on an outer circumference face of the rotor and performs suction. compression, expansion and exhaust strokes according to a cycle. At least one partitioning valve is elastically projected into the rotor chamber at a position where the combustion chamber is formed in the rotor housing. The partitioning valve is linearly in contact with an outer circumference face of the rotor and maintains a substantially airtight state. The number of partitioning valves preferably corresponds to the number of combustion chambers provided.

### TECHNICAL FIELD

The present invention relates to an O-ring type rotary engine and, more particularly, to a rotary engine having a rotor which operates with a circularly symmetrical rotational operation.

### BACKGROUND ART

In general, internal combustion engines can be classified into either reciprocating engines or rotary engines. Reciprocating engines are known to have suction, compression, expansion and exhaust strokes by a reciprocating movement of a piston within a cylinder and can be used as a power source by changing a linear movement of the piston to a rotational movement. In currently known rotary engines, the suction, compression, expansion and exhaust strokes are effected by an eccentrically rotary operation of a rotor which is formed in a substantially triangular shape and operates within an elliptical combustion chamber. In the rotary engine, the explosion force of the fuel mixture is outputted directly as a rotational movement.

The reciprocating engine type has a problem that a rotational speed is limited to a speed less than a constant speed, since an inertia loss occurs when the connecting rod changes direction at a top dead center and a bottom dead center, e.g., where a piston reaches a peak and a lowest point. Further, in the expansion stroke, the maximum explosion force occurs at an initial time, but there is a problem that the explosion force is not maximized to a rotation force at the peak point of the top dead center having an inertia influence of a piston.

Conventional rotary engines have a known problem in that the rotor rotates eccentrically resulting in reduced rotational stability and reduced efficiency.

### OBJECTS AND SUMMARY OF THE INVENTION

It is, therefore, an object of the invention to provide a rotary engine capable of preventing an output loss owing to an inertia loss in a reciprocating engine and an output loss owing to an eccentrically rotary operation of a rotary engine.

The present rotary engine is generally composed of a rotor housing having a substantially cylindrical rotor chamber and a specific combustion chamber formed in its outside. A rotor is provided which operates within the rotor housing and rotates in a circularly symmetrical fashion.

In accordance with the present invention, the engine is constructed with a rotor housing having a rotor chamber formed in a cylindrical shape in the inside thereof and sealed at the opposing ends, such as by a cover at each end. At least one combustion chamber is provided which is coupled through the rotor chamber in one side thereof to provide a combustion space for a fuel mixture. A suction expansion valve is provided for opening and closing a passage directed into the combustion chamber and an intake pipe in the rotor chamber of the rotor housing. A compression exhaust valve is provided for opening and closing a passage directed into the combustion chamber and an exhaust pipe, in the rotor chamber of the rotor housing. A rotor is installed in an axial relationship within the rotor chamber of the rotor housing. The rotor includes at least one movable lug projecting therefrom. The movable lug is preferably formed on an outer circumference face of the rotor and performs suction. compression, expansion and exhaust strokes according to a cycle. At least one partitioning valve is elastically projected into the rotor chamber at a position where the combustion chamber is formed in the rotor housing. The partitioning valve is linearly in contact with an outer circumference face of the rotor and maintains a substantially airtight state. The number of partitioning valves preferably corresponds to the number of combustion chambers provided.

### BRIEF DESCRIPTION OF THE DRAWINGS

The above and other objects and features of the instant invention will become apparent from the following description of preferred embodiments taken in conjunction with the accompanying drawings, in which:

FIG. 1 is a sectional-side view illustrating a low-speed engine embodiment in accordance with the present invention;

FIG. 2 is a sectional-front view illustrating a low-speed engine embodiment of the present invention;

FIGS. 3A-3C are operational state views of a low-speed engine embodiment of the invention;

FIG. 4 is a sectional-side view showing a high-speed engine embodiment in accordance with the present invention;

FIG. 5 is a sectional-front view illustrating a high-speed engine embodiment of the invention;

FIGS. 6A-6F are operational state diagrams of a high-speed engine embodiment of the invention;

FIG. 7 shows a decomposition perspective view of a suction expansion valve in one embodiment of the invention;

FIG. 8 presents a decomposition perspective view of a compression exhaust valve in one embodiment of the invention;

FIG. 9 is a perspective view of a partitioning valve in one embodiment of the invention;

FIG. 10 is a schematic diagram of a side view of a partitioning valve in one embodiment of the invention; and

FIG. 11 is a cross sectional view of a combustion chamber in one embodiment of the invention.

### DETAILED DESCRIPTION OF PREFERRED EMBODIMENTS

The present invention is described in detail in connection with exemplary embodiments thereof and by referring to the accompanying drawings.

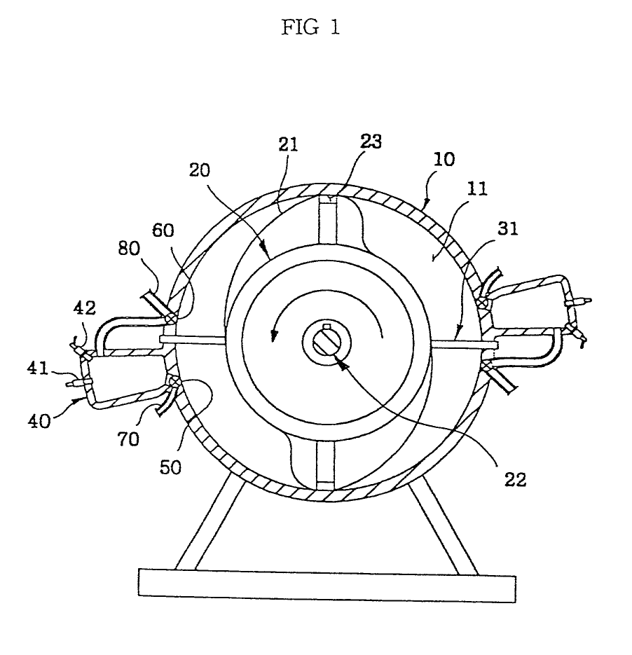

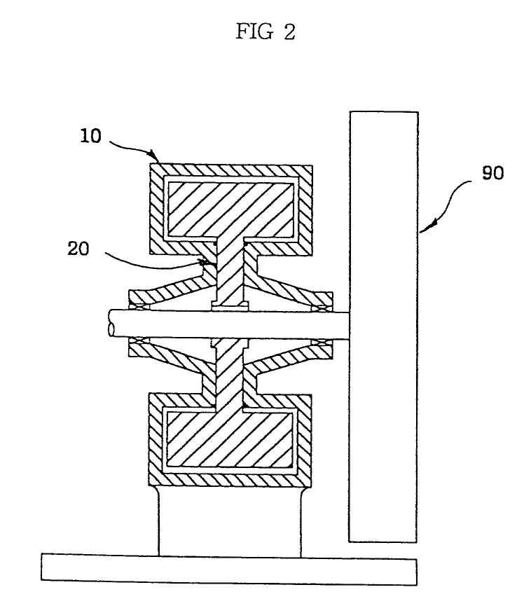

Referring to FIGS. 1, 2 and 5, a rotor housing 10 having an accommodation for a rotor 20 can be embodied in a number of columns with a common rotor shaft 22 coupled there through. One side of the rotor shaft 22 can be coupled to a fly wheel 90 which insures a rotation inertia force. The rotor 20 includes a movable lug 21 which can be provided with a sealing ring 23 for maintaining a substantially airtight engagement with an inner face of the rotor housing 10, so as to improve the efficiency of the operational stroke of a suction, a compression, an expansion and an exhaust stroke.

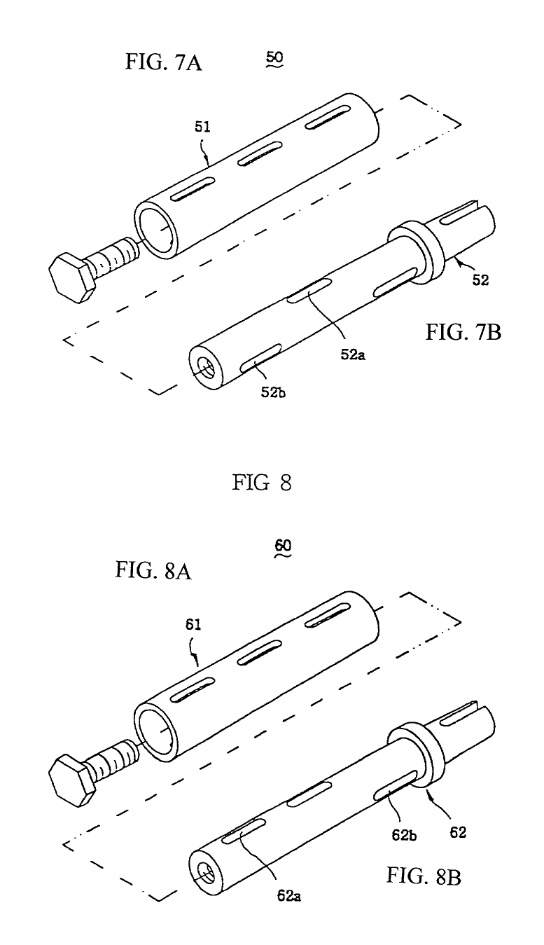

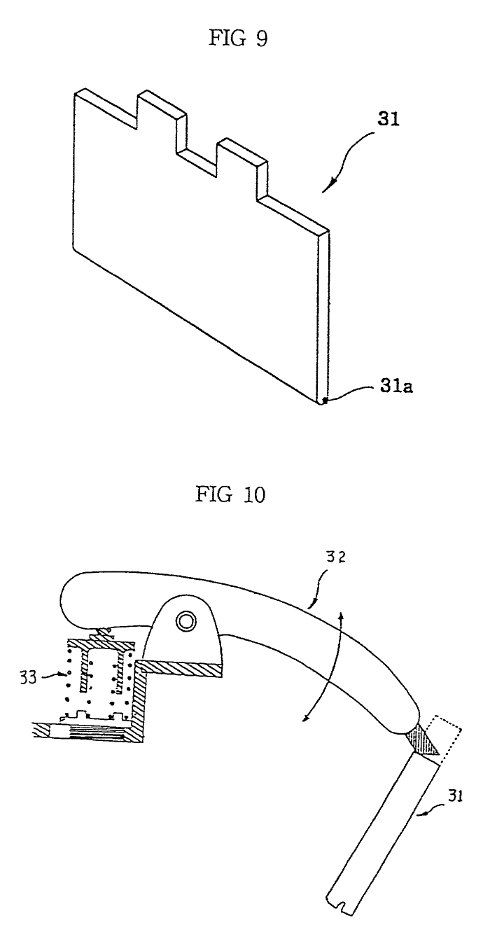

A suction expansion valve 50 and a compression exhaust valve 60 are provided and control the fluid communication between the interior of the rotor housing 10 and the combustion chamber 40 and an exhaust pipe 80, respectively. Preferably, the suction expansion valve 50 and the compression exhaust valve 60 are 3-way valves. In one embodiment. the suction expansion valve 50 and the compression exhaust valve 60 are constructed with a guide 51, 61 (See FIGS. 7, 8) formed as a pipe body having numerous air passages symmetrically formed, and a valve body 52, 62 which is combined with the guide 51,61 and can be rotatably moved through a movable connection to the rotor shaft 22. In this construction, the valve body 52, 62 includes an expansion hole 52b or a compression hole 62a which couples the combustion chamber 40 and the rotor chamber 11 so as to be in fluid communication with each other. At a position where the combustion chamber 40 is not formed, the valve body 52,62 also has a suction hole 52a or an exhaust hole 62b which forms an angle with respect to the expansion hole 52b or the compression hole 62a and pierces through an outer circumference face in one side of the shaft line so as to be connected through each of an intake pipe 70 and an exhaust pipe 80. Alternatively, a plate valve can be formed in a plate body, which is rotated movably centering around one shaft so that the rotor chamber 11 is connected through the combustion chamber 40 or other outer member through the intake pipe 70 and the exhaust pipe 80.

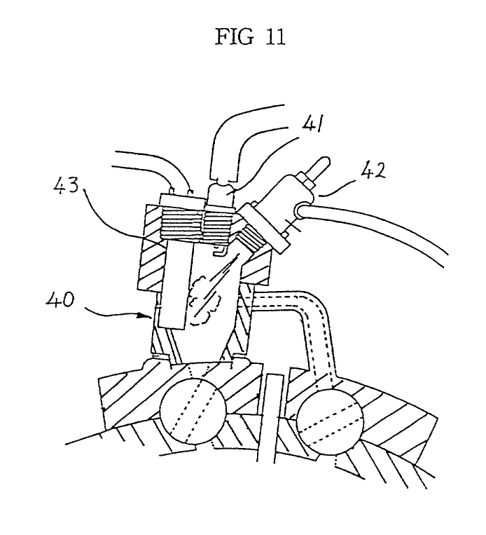

The engine includes at least one partitioning valve 31 which is associated with a corresponding combustion chamber 40. An exemplary embodiment of the partitioning valve 31 is illustrated in FIGS. 10 and 11. An upper part of the partitioning valve 31 is installed in the rotor housing 10 and is elastically supported by a rocker arm 32 which is elastically biased by a spring 33. The lower part of the partitioning valve 31 contacts an outer circumference face of the rotor 20. The partitioning valve 31 preferably has a flute 31 a formed in a length direction, which is provided to maintain a substantially airtight interface with the rotor 20 and also to reduce any friction force at the contact of the rotor 20.

The combustion chamber 40 is illustrated in further detail in FIG. 11. In the case where gasoline is used as a fuel, which has high volatility, an ignition plug 41 for firing the fuel mixture and a fuel atomization unit, such as a fuel injection nozzle 42, are provided in the combustion chamber 40. A preheating heater 43 can also be provided for initial starting. A fuel atomization unit can also be placed in the intake pipe 70, such as by using a fuel injection nozzle or a carburetor as the fuel atomization unit equipped with the intake pipe 70.

In an embodiment wherein light oil, such as diesel, is used as the combustion fuel, it is also desirable that a fuel atomization unit, such as the fuel injection nozzle 42, and the preheating heater 43 are provided within the combustion chamber 40.

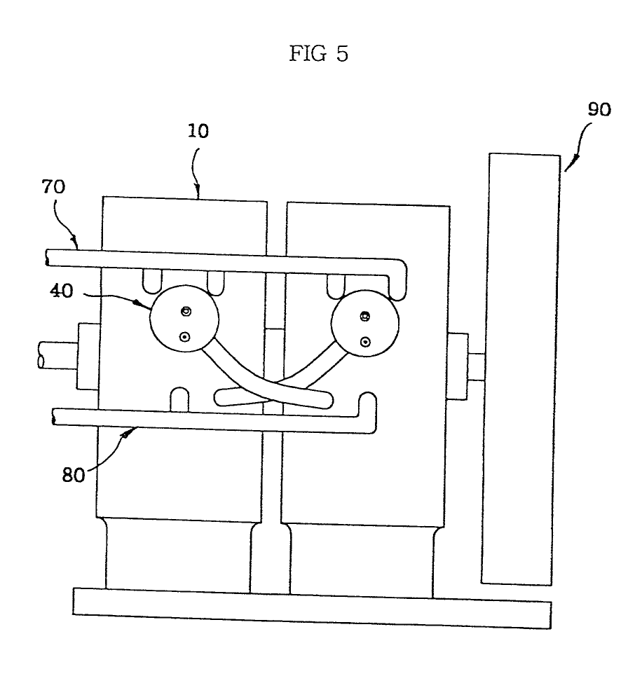

Referring to FIG. 5, in the case where only one combustion chamber 40 and one movable lug 21 of the rotor 20 are formed therein, it is desirable that the rotors 20 are formed in an even number of columns for the sake of an efficient operation of the engine. As illustrated in FIG. 5, a compression pipe path of one side rotor housing 10 is connected through the combustion chamber 40 of another side rotor housing 10 and a compression pipe path of another side rotor housing 10 is connected to one side rotor housing 10 in mutual intersection.

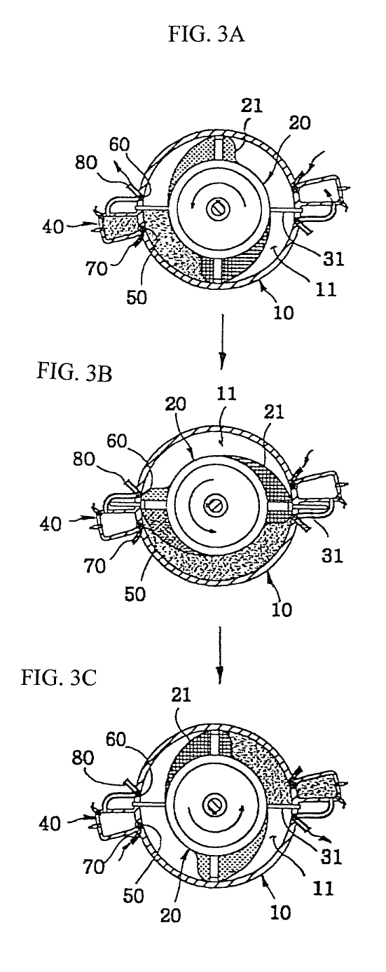

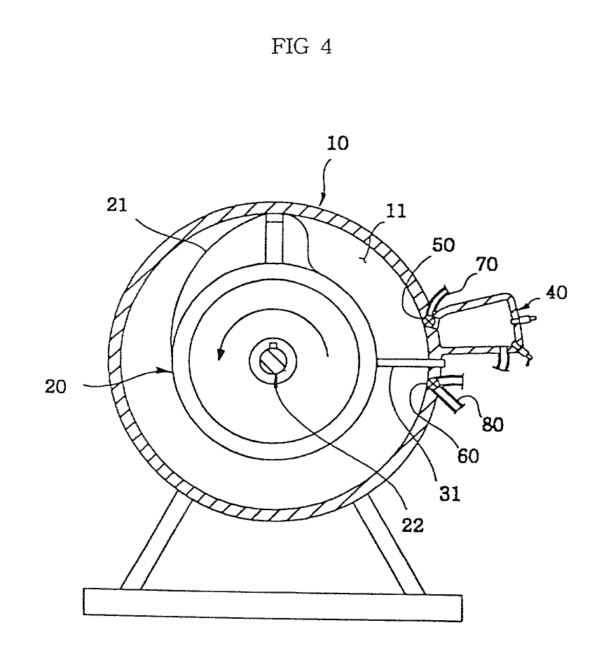

The operation of the invention is described in connection with FIGS. 3A-3C. In the invention constructed with the rotor housing 10 having the combustion chamber 40 and with the rotor 20 accommodated into the rotor chamber 11 of the rotor housing 10 and rotated circularly therein, in a case of a low-speed engine having two or more combustion chambers 40 and over two movable lug 21 of the rotor 20, the suction, compression, expansion and exhaust strokes are performed such that one side combustion chamber 40a is compressed and another side combustion chamber 40b is expanded. Further, one side movable lug 21a of the rotor 20 is movably rotated and air from the outside is sucked through one side suction expansion valve 50, thereby its rotation operation is gained through this suction stroke. As the rotor 20 movably rotates another side movable lug 21b passes by the partitioning valve 31 and air drawn in through the suction-stroke by another side movable lug 21 is compressed through the compression exhaust valve 60 and supplied to the combustion chamber 40, whereby the compression stroke is obtained. (FIG. 3B) when the movable lug 21 performing the compression stroke movably rotates by 180 degrees and passes by the partitioning valve 31, fuel is injected into air compressed and supplied to the combustion chamber 40 and a firing explosion is done and the air is expanded through the suction expansion valve 50 and flows in the rotor chamber 11 thereby pushing the rear face of the movable lug 21 passed by the partitioning valve 31 and rotate it movably (FIG. 3C).

From a time point when the movable lug 21 rotated by the expansion gas passes by the partitioning valve 31 with the rotation in 180 degrees, the expansion gas is exhausted to the outside through the compression exhaust valve 70 by the movable lug 21 of an opposite side, and thereby the engine operates by performing the above procedures repeatedly.

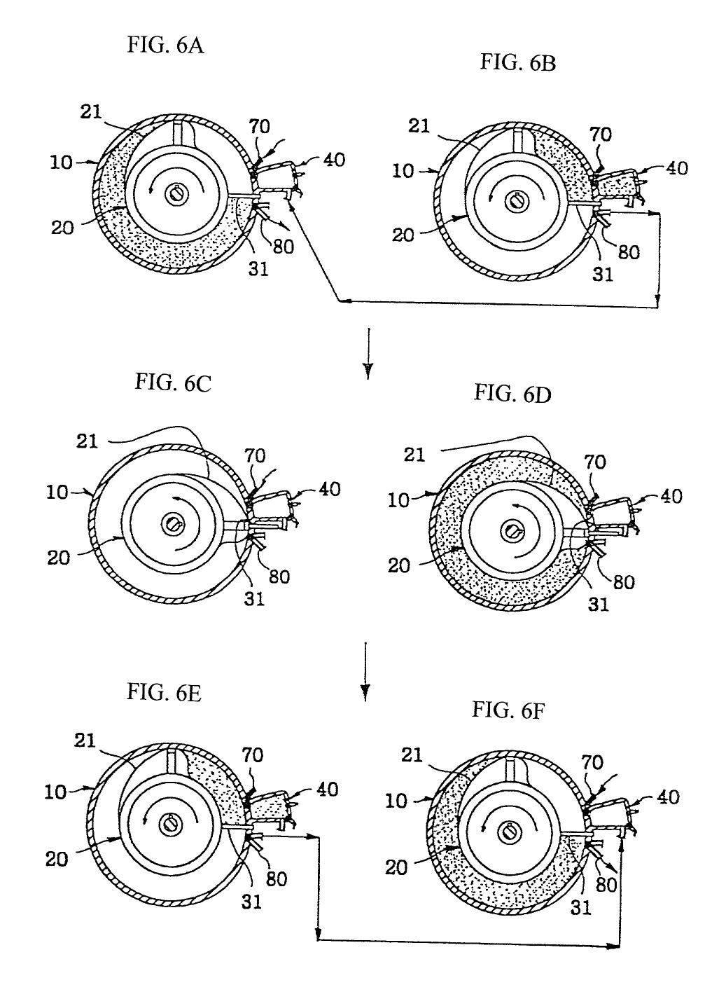

FIGS. 6A-6D illustrate the operation in the case where the combustion chamber 40 and the movable lug 21 of the rotor 20 are provided in one and the compression pipe paths are connected in intersection, when air flows in one side rotor chamber 11 in a state that the suction expansion valve 50 of one side rotor housing 10 sucks air, the air compressed by another side rotor 20 flows in through the compression pipe path, and at this time, the combustion chamber 40 of another side rotor chamber 11 has a state that the expansion stroke based on an explosion of a fuel mixture performed.

As mentioned above, when the movable lug 21 passes by the partitioning valve 31 in such a state that the suction stroke of air to one side rotor chamber 11 is completed and the compression stroke in the combustion chamber 40 is completed, the explosion stroke having an explosion of the mixture gas is performed in the combustion chamber 40 and the air rapidly flows into the rotor chamber 11 to rotate the movable lug 21. The air flowing into an opposite side of this movable lug 21 is supplied to another side combustion chamber 40. In this way, two rotors 20 can operate mutually orthogonally to rotate the rotor shaft 22 at a high speed.

In accordance with the present invention. an initially high gas pressure provided in an expansion stroke is translated directly to a rotating force. In this case, about twice the rotation force can be provided in comparison with a reciprocating engine. Also a progression speed of a work executed initially in an expansion stroke, namely, a movement speed of a rotor, is over about 2.5 times faster than that of the reciprocating engine. Accordingly, a thermal loss is minimized.

Furthermore, in the present engine, rotational stability is improved since the rotor performs a circular movement. Further, engine knocking is reduced since a firing and combustion timing can be selected freely, accordingly a thermal efficiency is increased by improving a compression ratio.

In addition, in a case of a low-speed type, there are two expansion strokes per one rotation of the rotor and a crank mechanism is omitted. Therefore, the invention has advantages in a small size and a high horsepower, and weight and volume per horsepower can be reduced to about ⅙ of the reciprocating engine. In a case of a high speed type, two cylinders connected in parallel alternatively have an expansion stroke, the size of each cylinder is small, and the crank mechanism is omitted. Accordingly, weight and volume per horsepower can be reduced to about ½ of a comparable reciprocating engine.

Additionally, an initial combustion starts in a high temperature state since a specific combustion chamber is provided therein. One benefit on this is that the exhaust of harmful gas such as HC, CO etc. is reduced, and an occurrence of NOx is minimized since the present structure promotes an eddy flow of compression air which flows into the inside of a cylinder after its partial combustion in a combustion chamber.

Although the invention has been shown and described with respect to the preferred embodiments, it will be understood by those skilled in the art that various changes and modifications may be made without departing from the spirit and scope of the invention as defined in the following claims.

What is claimed is:

1. An O-ring type rotary engine comprising:
a rotor housing having a rotor chamber formed therein having a cylindrical shape;
at least one combustion chamber, said at least one combustion chamber being in fluid communication with said rotor chamber and providing a combustion space for a fuel mixture;
a suction expansion valve, said suction expansion valve opening and closing a passage directed into the combustion chamber and an intake pipe in the rotor chamber of the rotor housing;
a compression exhaust valve, said compression exhaust valve opening and closing a passage directed into the combustion chamber and an exhaust pipe in the rotor chamber of the rotor housing;
a rotor axially installed in said rotor chamber, said rotor having at least one movable lug, wherein said movable lug is formed on an outer circumference face thereof and performs suction, compression, expansion and exhaust strokes according to a cycle; and
at least one partitioning valve corresponding to said at least one combustion chamber, each said partitioning valve being elastically projected into the rotor chamber at a position where the combustion chamber is formed in the rotor housing, said partitioning valve contacting an outer circumference face of the rotor and maintaining a substantially airtight state and also being provided in the same quantity of the combustion chambers.

2. The O-ring type rotary engine of claim 1, wherein a plurality of rotors and rotor housings are provided in a column quantity based on an even number, a compression pipe path of a first one of said rotor housings being connected through the combustion chamber of a second one of said rotor housings, and a compression pipe path said second rotor housing being connected to said first rotor housing.

3. The O-ring type rotary engine of any one claim among claims 1 to 2, wherein said suction expansion valve and compression exhaust valve are a 3-way valve and are constructed by a guide as a pipe body having numerous air passages symmetrically formed thereon and by a valve body which is combined with the guide and rotatably moved through a movable connection to the rotor shaft; and
said valve body has a first aperture which couples the combustion chamber and the rotor chamber so as to be connected through each other, at a position where the combustion chamber is formed, and also has a second aperture, which forms an angle with the first aperture and couples the intake pipe and the exhaust pipe, at a position where the combustion chamber is not formed.

4. The O-ring type rotary engine of any one claim among claims 1 through 2. wherein said combustion chamber comprises an ignition plug.

5. The O-ring type rotary engine of any one claim among claims 1 to 2, wherein said combustion chamber includes a preheating heater.

6. The O-ring type rotary engine of any one claim among claims 1 to 2, wherein said combustion chamber includes a fuel atomization device.

7. The O-ring type rotary engine of any one claim among claims 1 through 2, wherein said intake pipe comprises fuel atomization means.

8. The O-ring type rotary engine of any one claim among claims 1 to 2, wherein a lower part of said partitioning valve includes a flute portion.

9. The O-ring type rotary engine of any one claim among claims 1 through 2, wherein an end part of said movable lug of the rotor comprises an airtight maintaining ring for an airtight maintenance with an inner face of the rotor housing.
